(19) United States
(12) Patent Application Publication
(10) Pub. No.: US 2012/0216724 A1
(43) Pub. Date: Aug. 30, 2012

(54) Sulphonic Acid And Aromatic Groups Containing Hardening Accelerator Compositions

(75) Inventors: Luc Nicoleau, Altenmarkt an der Alz (DE); Gerhard Albrecht, Prien am Chiemsee (DE); Klaus Lorenz, Zangberg (DE); Mario Vierle, Wasserburg (DE); Michael Breau, Trostberg (DE); Christoph Hesse, Trostberg (DE)

(73) Assignee: Construction Research & Technology GmbH, Trostberg (DE)

(21) Appl. No.: 13/392,962

(22) PCT Filed: Aug. 13, 2010
(86) PCT No.: PCT/EP2010/061809

§ 371 Date: May 11, 2012

(30) Foreign Application Priority Data
Sep. 2, 2009 (EP) 09169274.9

(51) Int. Cl. C04B 24/18; C04B 24/30; C08K 3/28

(52) U.S. Cl. 106/808; 524/429; 106/823; 524/2

(57) ABSTRACT

The invention concerns a process for the preparation of a hardening accelerator composition by reaction of a water-soluble calcium compound with a water-soluble silicate compound and by reaction of a calcium compound with a silicon dioxide containing component under alkaline conditions, in both cases the reaction being carried out in the presence of an aqueous solution of a water-soluble polymer, which contains sulphonic acid and/or sulphonate groups and aromatic groups. The invention concerns also the reaction product of said processes and its use as hardening accelerator for building materials.

The present invention relates to a process for the preparation of a hardening accelerator composition, the hardening accelerator composition and the use of the hardening accelerator composition.

It is known that admixtures in the form of dispersants are often added to aqueous slurries of pulverulent inorganic or organic substances, such as clays, silicate powders, chalks, carbon blacks, powdered rocks and hydraulic binders, for improving their workability, i.e. kneadability, spreadability, sprayability, pumpability or flowability. Such admixtures are capable of breaking up solid agglomerates, dispersing the particles formed and in this way improving the fluidity. This effect is also utilised in a targeted manner in particular in the preparation of building material mixtures which contain hydraulic binders, such as cement, lime, gypsum, calcium sulphate hemihydrate (bassanite), anhydrous calcium sulphate (anhydrite), or latent hydraulic binders, such as fly ash, blast furnace slag or pozzolans.

In order to convert these building material mixtures based on said binders into a ready-to-use, workable form, as a rule substantially more mixing water is required than would be necessary for the subsequent hydration and hardening process. The proportion of cavities which are formed in the concrete body by the excess water which subsequently evaporates leads to significantly poorer mechanical strengths and durabilities.

In order to reduce this excess proportion of water at a predetermined processing consistency and/or to improve the workability at a predetermined water/binder ratio, admixtures which are generally referred to as water-reducer compositions or plasticizers are used. In particular water-soluble polymers, which contain sulphonic acid and/or sulphonate groups and aromatic groups are known in the prior art, for example β-naphthalene-sulphonate-formaldehyde condensates (“BNS”), melamine-sulphonate-formaldehyde-condensates (“MFS”) and lignosulphonates (a by-product from the production of cellulose).

Furthermore, admixtures for building material mixtures comprising hydraulic binders typically also contain hardening accelerators which shorten the setting time of the hydraulic binder. According to WO 02/070425, calcium silicate hydrate in particular present in dispersed (finely or particularly finely dispersed) form, can be used as such a hardening accelerator. However, commercially available calcium silicate hydrate or corresponding calcium silicate hydrate dispersions may be regarded only as hardening accelerators which have little effect.

The object of the present invention is therefore to provide a composition which acts in particular as a hardening accelerator and moreover performs as a plasticizer.

This object is achieved by a process for the preparation of a hardening accelerator composition by reaction of a water-soluble calcium compound with a water-soluble silicate compound, the reaction of the water-soluble calcium compound with the water-soluble silicate compound being carried out in the presence of an aqueous solution of a water-soluble polymer, which contains sulphonic acid and/or sulphonate groups and aromatic groups.

In principle, only relatively slightly water-soluble compounds are also suitable in each case as water-soluble calcium compounds and water-soluble silicate compounds, although readily water-soluble compounds (which dissolve completely or virtually completely in water) are preferred in each case. However, it must be ensured there is a sufficient reactivity for the reaction in the aqueous environment with the corresponding reactant (either water-soluble calcium compound or water-soluble silicate compound). It is to be assumed that the reaction takes place in aqueous solution but a water-insoluble inorganic compound (calcium silicate hydrate) is usually present as a reaction product.

In principle, the accelerator contains an organic and an inorganic component. The organic component is at least one water-soluble polymer, which contains sulphonic acid and/or sulphonate groups and aromatic groups. In this patent application the term “water-soluble polymer according to this invention” will replace the detailed wording “water-soluble polymer, which contains sulphonic acid and/or sulphonate groups and aromatic groups” throughout the whole document. Sulphonic acid groups provide the necessary water-solubility to the polymers. The term “aromatic groups” comprises also heteroaromatic systems like for examples triazines and similar heteroaromates. It is possible to preferably select the water-soluble polymer, which contains sulphonic acid and/or sulphonate groups and aromatic groups from (β-naphthalene-sulphonate-formaldehyde condensates (“BNS”), melamine-sulphonate-formaldehyde-condensates (“MFS”), lignosulphonates (a by-product from the production of cellulose), copolymers obtainable by radical polymerization of ethylenically unsaturated monomers like for example from styrene and 2-acrylamido-2-methylpropane sulfonic acid, from styrene sulphonic acid (as a homopolymer or as a copolymer with other suitable monomers like styrene and/or 2-acrylamido-2-methylpropane sulfonic acid).

In each case the respective salt forms (sulphonates) of the sulphonic acids are included. Preferable are β-naphthalene-sulphonate-formaldehyde condensates (“BNS”), melamine-sulphonate-formaldehyde-condensates (“MFS”) and/or lignosulphonates. More preferable are β-naphthalene-sulphonate-formaldehyde condensates (“BNS”) and/or lignosulphonates.

Sulphonic acid group containing s-triazines and naphthalene-formaldehyde condensates are broadly disclosed by prior art documents and frequently used as water reducing agents or plasticizers for cement based systems such as concrete. β-naphthalene-sulphonate-formaldehyde condensates (“BNS”), also known as naphthalene-formaldehyde sulphonates (“NFS”) disperse cement particles by an electrostatic repulsion that results from adsorption processes. Usually, such condensates suitable as plasticizer or dispersants are prepared by the reaction of aromatic sulphonic acids like naphthalene sulphonic acid with formaldehyde at ambient pressure and at temperatures up to 100° C. The ratio between formaldehyde and the sulphonated naphthalene component is usually from 0.7 up to 3.5, preferably from 0.8 to 1. The preparation and use of BNS is well known state of the art and disclosed for example in U.S. Pat. No. 4,725,665 and U.S. Pat. No. 3,686,133.

Melamine-sulphonate-formaldehyde-condensates (“MFS”) are broadly used as flow improving agents in the processing of hydraulic binder containing compositions such as dry mortar mixtures, pourable mortars and other cement bonded construction materials. Melamine mainly is used in this connection as the enamel s-triazine, therefore these agents are known as MFS resins. They cause as well as the already mentioned BNS representatives a strong liquefaction of the construction chemicals mixture. It is well known that commercially available flow improving agents based on melamine-formaldehyde-sulphite such as products of the Melment series of BASF Construction Polymers GmbH, Germany, cause an excellent liquefying effect even of low dosages of about 0.3 to 1.2 weight %, relative to the weight of the hydraulic binder such as cement. Melamine-sulphonate-formaldehyde-condensates (“MFS”) are described in the prior art for example in the documents CA-A1-2172004, DE-A1-44 11 797, U.S. Pat. No. 4,430,469 and U.S. Pat. No. 6,555,683.

CA-A1-2172004 discloses a water soluble polycondensation product based on an amino-s-triazine and its use as plasticizer in aqueous binder containing suspensions based on cement, lime and gypsum. These polycondensates are obtainable in two condensation steps whereby in a pre-condensation step the amino-s-triazine, the formaldehyde component and the sulphite are condensated at a molar ratio of 1 to 0.5:5.0 to 0.1:1.5. Melamine is a preferred representative of amino-s-triazines. Further suitable representatives are amino plast former selected from the group urea, thiourea, dicyandiamide or guanidine and guanidine salts.

According to DE-A1-44 11 797 sulfanilic acid containing condensation products based on amino-s-triazines that show at least two amino groups are prepared by using formaldehyde. The sulfanilic acid is used in amounts from 1.0 to 1.6 mol per mol amino-s-triazine and neutralized in aqueous solution with an alkaline metal hydroxide or in earth alkaline metal hydroxide. In an additional step the formaldehyde is added in amounts of from 3.0 to 4.0 mol per mol amino-s-triazine at a pH between 5.0 to 7.0 and at temperatures between 50 and 90° C. The final viscosity of the solution shall be between 10 and 60 cSt at 80° C.

According to U.S. Pat. No. 4,430,469 highly concentrated and low viscous aqueous solutions of melamine/aldehyde resins are capable by reacting melamine and an aldehyde in an alkaline medium in a first step with a component selected from the group comprising alkali sulphate, earth alkali sulphate or (earth) alkali sulphonate or other suitable amino compounds to a pre-condensate. This mixture in an additional process step is reacted with another amino compound such as amino acids or amino carbonic acids and finally the resin solution is brought to an alkaline pH.

U.S. Pat. No. 6,555,683 discloses a condensate based on an amino-s-triazine with at least two amino groups and formaldehyde and a high content of sulphonic acid groups and a low content of formiate. Such products can be prepared according to this document by reacting the amino-s-triazine, formaldehyde and a sulphite at a molar ratio of 1:3.0:6.0:1.51:2.0 in an aqueous solution and at a temperature between 60 and 90° C. and a pH between 9.0 and 13.0 until the sulphite is no longer present. In an additional step the condensation process is conducted at a pH between 3.0 and 6.5 and at temperatures between 60 and 80° C. until the condensation product at 80° C. shows a viscosity between 5 and 50 mm²/s. Finally, the condensation product is to be brought to a pH between 7.5 and 12.0 or treated thermally by a pH 10.0 and a temperature between 60 and 100° C.

Lignosulphonates are well-known as water-reducers for cementitious products like concrete and mortar. Typically these products are a by-product from the production of cellulose and are made from wood pulp waste. In this process the lignin is made water- soluble by a sulphonation process and in this way separated from the much less good water-soluble cellulose. The lignosulphonates are typically present in their salt form as sodium and/or calcium salts or also as magnesium salts. Products are offered in the market especially from the Norwegian company (Borregaard LignoTech), for example under the product name Borresperse.

Preferably the water-soluble polymer, which contains sulphonic acid and/or sulphonate groups and aromatic groups fulfils the requirements of the industrial standard EN 934-2 (February 2002).

The inorganic component may be regarded as modified, finely dispersed calcium silicate hydrate, which may contain foreign ions, such as magnesium and aluminium. The calcium silicate hydrate is prepared in the presence of a water-soluble polymer according to this invention (organic component).

Usually, a suspension containing the calcium silicate hydrate in finely dispersed form is obtained, which suspension effectively accelerates the hardening process of hydraulic binders and can act as a plasticizer.

The inorganic component can in most cases be described with regard to its composition by the following empirical formula:

a CaO, SiO₂, b Al₂O₃, c H₂O, d X, e W

X is an alkali metal

W is an alkaline earth metal

0.1≦a≦2 preferably 0.66≦a≦1.8

0≦b≦1 preferably 0≦b≦0.1

1≦c≦6 preferably 1≦c≦6.0

0≦d≦1 preferably 0≦d≦0.4

0≦e≦2 preferably 0≦e≦0.1

In a preferred embodiment, the aqueous solution also contains, in addition to silicate and calcium ions, further dissolved ions which are preferably provided in the form of dissolved aluminium salts and/or dissolved magnesium salts. As aluminium salts preferably aluminium halogens, aluminium nitrate, aluminium hydroxide and/or aluminium sulphate can be used. More preferable within the group of aluminium halogens is aluminium chloride. Magnesium salts can be preferably magnesium nitrate, magnesium chloride and/or magnesium sulphate.

Advantage of the aluminium salts and magnesium salts is that defects in the calcium silicate hydrate can be created via the introduction of ions different to calcium and silicon. This leads to an improved hardening acceleration effect. Preferably the molar ratio of aluminium and/or magnesium to calcium and silicon is small. More preferably the molar ratios are selected in a way that in the previous empirical formula the preferable ranges for a, b and e are fulfilled (0.66≦a≦1.8; 0≦b≦0.1; 0≦e≦0.1).

In a preferred embodiment of the invention, in a first step, the water-soluble calcium compound is mixed with the aqueous solution which contains a water-soluble polymer according to this invention so that a mixture preferably present as a solution is obtained, to which the water-soluble silicate compound is added in a subsequent second step. The water-soluble silicate compound of the second step can also contain the water-soluble polymer according to this invention.

The aqueous solution may also contain one or more further solvents (for example alcohols like ethanol and/or isopropanol) in addition to water. Preferably the weight proportion of the solvent other than water to the sum of water and further solvent (e.g. alcohol) is up to 20 weight %, more preferably less than 10 weight % and the most preferably less than 5 weight %. However most preferable are aqueous systems without any solvent.

The temperature range in which the process is carried out is not especially limited. Certain limits however are imposed by the physical state of the system. It is preferable to work in the range of 0 to 100° C., more preferable 5 to 80° C. and most preferable 15 to 35 ° C. High temperatures can be reached especially when a milling process is applied. It is preferable not to exceed 80° C.

Also the process can be carried out at different pressures, preferably in a range of 1 to 5 bars.

The pH-value depends on the quantity of reactants (water-soluble calcium compound and water-soluble silicate) and on the solubility of the precipitated calcium silicate hydrate. It is preferable that the pH value is higher than 8 at the end of the synthesis, preferably in a range between 8 and 13.5.

In a further preferred embodiment (embodiment 1), the aqueous solution containing the water-soluble polymer according to this invention furthermore has the water-soluble calcium compound and the water-soluble silicate compound as components dissolved in it. This means that the reaction of the water-soluble calcium compound and the water-soluble silicate compound in order to precipitate calcium silicate hydrate occurs in the presence of an aqueous solution which contains a water-soluble polymer according to this invention.

A further preferred embodiment (embodiment 2) is characterized in that a solution of a water-soluble calcium compound and a solution of a water-soluble silicate compound are added preferably separately to the aqueous solution containing a water-soluble polymer according to this invention.

To illustrate how this aspect of the invention can be carried out, for example three solutions can be prepared separately (solution (I) of a water-soluble calcium compound, solution (II) of a water-soluble silicate compound and a solution (III) of the water-soluble polymer according to this invention). Solutions (I) and (II) are preferably separately and simultaneously added to solution (III). Advantage of this preparation method is besides its good practicability that relatively small particle sizes can be obtained.

In a further preferred embodiment of the invention the above standing embodiment 2 can be modified in that the solution of a water soluble calcium compound and/or the solution of a water-soluble silicate compound contain a water-soluble polymer according to this invention. In this case the method is carried out in principle in the same way as described in the previous embodiment 2, but solution (I) and/or solution (II) preferably contain also the water-soluble polymer according to this invention. In this case the person skilled in the art will understand that the water-soluble polymer according to this invention is distributed to at least two or three solutions. It is advantageous that 1 to 50%, preferably 10 to 25% of the total of the water-soluble polymer according to this invention are contained in the calcium compound solution (e.g. solution (I)) and/or silicate compound solution (e.g. solution (I ( ).This preparation method has the advantage that the water-soluble polymer according to this invention is present also in the solution of the water-soluble calcium compound and/or the solution of the water-soluble silicate compound.

In a further preferred embodiment of the invention the previous embodiment 2 can be modified in that the aqueous solution containing a water-soluble polymer according to this invention contains a water-soluble calcium compound or a water-soluble silicate compound.

In this case the method is carried out in principle in the same way as described in the previous embodiment 2, but solution (III) would contain a water-soluble calcium compound or a water-soluble silicate compound. In this case the person skilled in the art will understand that the water-soluble calcium compound or the water-soluble silicate compound is distributed to at least two solutions.

In general, the components are used in the following ratios:

i) 0.01 to 75, preferably 0.01 to 51, most preferably 0.01 to 15% by weight of water-soluble calcium compound,

ii) 0.01 to 75, preferably 0.01 to 55, most preferably 0.01 to 10% by weight of water-soluble silicate compound,

iii) 0.001 to 60, preferably 0.1 to 30, most preferable 0.1 to 10% by weight of water-soluble polymer according to this invention,

iv) 24 to 99, preferably 50 to 99, most preferably 70 to 99% by weight of water.

Preferably the hardening accelerator composition is dosed at 0.01 to 10 weight %, most preferably at 0.1 to 2 weight % of the solids content with respect to the hydraulic binder, preferably cement. The solids content is determined in an oven at 60° C. until a constant weight of the sample is reached.

Often, the water-soluble calcium compound is present as calcium chloride, calcium nitrate, calcium formate, calcium acetate, calcium bicarbonate, calcium bromide, calcium carbonate, calcium citrate, calcium chlorate, calcium fluoride, calcium gluconate, calcium hydroxide, calcium hypochloride, calcium iodate, calcium iodide, calcium lactate, calcium nitrite, calcium oxalate, calcium phosphate, calcium propionate, calcium silicate, calcium stearate, calcium sulphate, calcium sulphate hemihydrate, calcium sulphate dihydrate, calcium sulphide, calcium tartrate calcium aluminate, tricalcium silicate and/or dicalcium silicate. Preferably the water-soluble calcium compound is not a calcium silicate. The silicates calcium silicate, dicalcium silicate and/or tricalcium silicate are less preferred because of low solubility (especially in the case of calcium silicate) and for economic reasons (price) (especially in case of dicalcium silicate and tricalcium silicate).

The water-soluble calcium compound is preferably present as calcium citrate, calcium tartrate, calcium formate and/or calcium sulphate. Advantage of these calcium compounds is their non-corrosiveness. Calcium citrate and/or calcium tartrate are preferably used in combination with other calcium sources because of the possible retarding effect of these anions when used in high concentrations.

In a further embodiment of the invention the calcium compound is present as calcium chloride and/or calcium nitrate. Advantage of these calcium compounds is their good solubility in water, low price and good availability.

Often, the water-soluble silicate compound is present as sodium silicate, potassium silicate, waterglass, aluminium silicate, tricalcium silicate, dicalcium silicate, calcium silicate, silicic acid, sodium metasilicate and/or potassium metasilicate.

The water-soluble silicate compound is preferably present as sodium metasilicate, potassium metasilicate and/or waterglass. Advantage of these silicate compounds is their extremely good solubility in water.

Preferably species of different types are used as the water-soluble silicate compound and as the water-soluble calcium compound.

In a preferable process water-soluble alkali metal ions (for example lithium, sodium, potassium . . . ) are removed from the hardening accelerator composition by cation exchangers and/or water-soluble nitrate and/or chloride ions are removed from the hardening accelerator composition by anion exchangers. Preferably the removal of said cations and/or anions is carried out in a second process step after the preparation of the hardening accelerator composition by the use of the ion exchangers. Acid ion exchangers suitable as cation exchanger are for example based on sodium polystyrene sulfonate or poly-2-acrylamido-2-methylpropane sulfonic acid (poly AMPS). Basic ion exchangers are for example based on amino groups, like for example poly (acrylamido-N-propyltrimethylammonium chloride) (poly APTAC).

The invention concerns also a process for the preparation of a hardening accelerator composition by reaction of a calcium compound, preferably a calcium salt, most preferably a water-soluble calcium salt with a silicon dioxide containing component under alkaline conditions characterized in that the reaction is carried out in the presence of an aqueous solution of a water-soluble polymer according to this invention.

Typically the calcium compounds are calcium salts (e.g. calcium salts of carboxylic acids). The calcium salt can be for example calcium chloride, calcium nitrate, calcium formate, calcium acetate, calcium bicarbonate, calcium bromide, calcium carbonate, calcium citrate, calcium chlorate, calcium fluoride, calcium gluconate, calcium hydroxide, calcium oxide, calcium hypochloride, calcium iodate, calcium iodide, calcium lactate, calcium nitrite, calcium oxalate, calcium phosphate, calcium propionate, calcium silicate, calcium stearate, calcium sulphate, calcium sulphate hemihydrate, calcium sulphate dihydrate, calcium sulphide, calcium tartrate, calcium aluminate, tricalcium silicate and/or dicalcium silicate. Preferable are calcium hydroxide and/or calcium oxide because of their strong alkaline properties. Preferably the water-soluble calcium compound is not a calcium silicate. The silicates calcium silicate, dicalcium silicate and/or tricalcium silicate are less preferred because of low solubility (especially in the case of calcium silicate) and for economic reasons (price) (especially in case of dicalcium silicate and tricalcium silicate). Less preferable are also not so good soluble calcium salts like for example calcium carbonate and also calcium salts with retarding anions (e.g. citrate, gluconate, tartrate can retard the hardening of hydraulic binders). In the case of neutral or acid calcium salts (e.g. calcium chloride or calcium nitrate) it is preferable to use a suitable base to adjust the pH-value to alkaline conditions (e.g. lithium hydroxide, sodium hydroxide, potassium hydroxide, ammonia, magnesium hydroxide or any other earth alkali hydroxide). Preferable is a pH-value higher than 8, more preferable higher than 9 and most preferable higher than 11. The pH-value is measured preferably at 25° C. and with a solid content of the suspension of 1 weight %.

It is possible to use any material which contains silicon dioxide, for example microsilica, pyrogenic silica, precipitated silica, blast furnace slag and/or quartz sand. Small particle sizes of the silicon dioxide containing material are preferable, especially particle sizes below 1 μm. Further it is possible to use compounds which are able to react in an aqueous alkaline environment to silicon dioxide like for example tetraalkoxy silicon compounds of the general formula Si(OR)₄. R can be the same or different and can be for example selected from a branched or non-branched C1 to C10 alkyl group. Preferably R is methyl, especially preferably ethyl.

In a preferred embodiment the silicon dioxide containing compound is selected from the group of microsilica, pyrogenic silica, precipitated silica, blast furnace slag and/or quartz sand. Preferable are microsilica, pyrogenic silica and/or precipitated silica, especially precipitated and/or pyrogenic silica. The types of silica, which are listed above are defined in Ullmann's Encyclopedia of Industrial Chemistry, Wiley-VCH, Release 2009, 7^{th} Edition, DOI 10.1002/14356007.a23_{—}583.pub3.

It is preferable to apply mechanical energy, preferably by milling, to the reaction mixture in order to activate and/or accelerate the reaction of the calcium salt with the usually low water-soluble silicon dioxide containing component. The mechanical energy is also advantageous in order to reach the desired small particle sizes of the calcium silicate hydrates. The wording “milling” means in this patent application any process in which high shear forces are exerted on the reaction mixture in order to accelerate the reaction and to obtain a suitable particle size. For example milling can be carried out in a planet ball mill in a continuous or batch operation mode. Alternatively an ultradisperser, preferably with a number of revolutions higher than 5.000 r.p.m. can be used. Also it is possible to apply a so-called shaker equipment in which small grinding bodies, preferably smaller than 1 mm in diameter are put together with the reaction mixture into a receptacle and are shaked. The respective shaker equipment is for example available from the company Skandex.

Typically the pH-value of the process for the preparation of a hardening accelerator is higher than 9.

Preferably the molar ratio of calcium from the calcium compound to silicon from the silicon dioxide containing component is from 0.6 to 2, preferably 1.1 to 1.8.

Typically the weight ratio of water to the sum of calcium compound and silicon dioxide containing component is from 0.2 to 50, preferably 2 to 10, most preferably 4 to 6. In this context water means the water in the reaction mixture, in which the process is carried out. It is preferable to carry out the process at relatively low water contents in order to increase the output of the process. Also it is possible to obtain relatively conveniently dry products from the wet products because not so much water has to be removed. A ratio of 2 to 10, respectively 4 to 6 is especially preferred because a paste like consistency of the products can be obtained, which is preferable for the milling process.

In a preferred embodiment the water-soluble polymer according to this invention is a polycondensate.

In a preferred embodiment the water-soluble polymer according to this invention is a plasticizer for hydraulic binders selected from the group of lignosulphonates, naphthalene sulphonate formaldehyde condensates and/or melamine sulphonate formaldehyde condensates. These plasticizers for hydraulic binders (for example cement) have proved to be especially efficient with respect to the acceleration effect of the hardening accelerators.

Typically the weight average molecular weight M_{w} of the water-soluble polymer according to this invention is between 1.000 and 100.000 g/mol, more preferably between 2.000 and 50.000 g/mol and most preferably between 5.000 and 20.000 g/mol. In particular the preferable range Mw for lignosulfonates is from 5.000 to 20.000 g/mol, for BNS from 5.000 to 10.000 g/mol and for melamine formaldehyde sulphonates from 2.000 to 10.000 g/mol.

It is preferred that the process according to this invention is carried out at a site of concrete production (for example a ready-mix concrete, precast concrete plant or any other plant where mortar, concrete or any other cementitious products are produced), characterized in that the obtained hardening accelerator composition is used as the batching water. The obtained hardening accelerator composition is an aqueous system and can be used directly as the batching water, especially when designing the hardening accelerators according to the specific needs of a job-site.

Batching water in this context is the water, which is used in concrete production or production of similar cementitious materials. Typically the batching water is mixed with cement and for examples aggregates at a ready mix concrete plant or precast concrete plant, at a construction site or any other place where concrete or other cementitious materials are produced. Usually the batching water can contain a wide range of additives like for example plasticizers, hardening accelerators, retarders, shrinkage reducing additives, air entrainers and/or defoamers. It is advantageous to produce the hardening accelerators according to this invention in the batching water intended for production of concrete or similar materials, because there is no need to transport the respective admixtures.

A further preferred embodiment of the invention, preferably carried out at a site of concrete production (for example a ready mix concrete or precast concrete plant) is characterized in that the weight ratio of the sum of water-soluble calcium compound, water-soluble silicate compound and water-soluble polymer according to this invention to water, preferably batching water, is between 1/1000 and 1/10, more preferably between 1/500 and 1/100. A high dilution of the suspensions is advantageous for the efficiency of the hardening accelerators.

In a preferred embodiment of the invention the process is characterized in that polycondensates containing

(I) at least one structural unit consisting of an aromatic or heteroaromatic moiety bearing a polyether side chain, preferably a poly alkylene glycol side chain, more preferably a poly ethylene glycol side chain and

(II) at least one structural unit consisting of an aromatic or heteroaromatic moiety bearing at least one phosphoric acid ester group and/or its salt are present in the aqueous solution which contains the water-soluble polymer, the water-soluble polymer containing sulphonic acid and/or sulphonate groups and aromatic groups.

Preferably the aqueous solution in which the reaction is carried out contains besides the water-soluble polymer, which contains sulphonic acid and/or sulphonate groups and aromatic groups, a second polymer. The second polymer is preferably a polycondensate as described in the previous text of this embodiment and following embodiments.

The polycondensates according to this embodiment are known in the prior art (US 20080108732 A1) to be effective as a superplasticiser in cementitious compositions. US 20080108732 A1 describes polycondensates based on an aromatic or heteroaromatic compound (A) having 5 to 10 C atoms or heteroatoms, having at least one oxyethylene or oxypropylene radical, and an aldehyde (C) selected from the group consisting of formaldehyde, glyoxylic acid and benzaldehyde or mixtures thereof, which result in an improved plasticizing effect of inorganic binder suspensions compared with the conventionally used polycondensates and maintain this effect over a longer period (“slump retention”). In a particular embodiment, these may also be phosphated polycondensates.

Typically the polycondensate contains (I) at least one structural unit consisting of an aromatic or heteroaromatic moiety bearing a polyether side chain, preferably a polyalkylene glycol side chain, more preferably a polyethylene glycol side chain. The structural unit consisting of an aromatic or heteroaromatic moiety bearing a polyether side chain, preferably a polyethylene glycol side chain is selected preferably from the group of alkoxylated, preferably ethoxylated, hydroxy-functionalized aromates or heteroaromates (for example the aromates can be selected from phenoxyethanol, phenoxypropanol, 2-alkoxyphenoxyethanols, 4-alkoxyphenoxyethanols, 2-alkylphenoxyethanols, 4-alkylphenoxyethanols) and/or alkoxylated, preferably ethoxylated, amino-functionalized aromates or heteroaromates (for example the aromates can be selected from N,N-(Dihydroxyethyl)aniline, N,-(Hydroxyethyl)aniline, N,N-(Dihydroxypropyl)aniline, N,-(Hydroxypropyl)aniline). More preferable are alkoxylated phenol derivatives (for example phenoxyethanol or phenoxypropanol), most preferable are alkoxylated, especially ethoxylated phenol derivatives featuring weight average molecular weights between 300 g/mol and 10,000 g/mol (for example polyethylenglycol monophenylethers). Typically the polycondensate contains (II) at least one phosphated structural unit consisting of an aromatic or heteroaromatic moiety bearing at least one phosphoric acid ester group and/or a salt of the phosphoric acid ester group, which is selected preferably from the group of alkoxylated hydroxy-functionalized aromates or heteroaromates (for example phenoxyethanol phosphate, polyethylenglycol monophenylether phosphates) and/or alkoxylated amino-functionalized aromates or heteroaromates (for example N,N-(Dihydroxyethyl)aniline diphosphate, N,N-(Dihydroxyethyl)aniline phosphate, N,-(Hydroxypropyl)aniline phosphate), which bear at least one phosphoric acid ester group and/or a salt of the phosphoric acid ester group (e.g. by esterification with phosphoric acid and optional addition of bases). More preferable are alkoxylated phenols bearing at least one phosphoric acid ester group and/or a salt of the phosphoric acid ester group (for example polyethylenglycol monophenylether phosphates with less than 25 ethylene glycol units) and most preferable are the respective alkoxylated phenols featuring weight average molecular weights between 200 g/mol and 600 g/mol (for example phenoxyethanol phosphate, polyethylenglycol monophenylether phosphates with 2 to 10 ethyleneglycol units), the alkoxylated phenols bearing at least one phosphoric acid ester group and/or a salt of the phosphoric acid ester group (e.g. by esterification with phosphoric acid and optional addition of bases).

In another embodiment of the invention the process is characterized in that in the polycondensate the structural units (I) and (II) are represented by the following general formulae

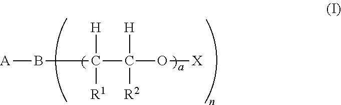

where

A are identical or different and are represented by a substituted or unsubstituted aromatic or heteroaromatic compound having 5 to 10 C atoms

where

B are identical or different and are represented by N, NH or O

where

n is 2 if B is N and n is 1 if B is NH or O

where

R¹ and R², independently of one another, are identical or different and are represented by a branched or straight-chain C₁- to C₁₀-alkyl radical, C₅- to C₈-cycloalkyl radical, aryl radical, heteroaryl radical or H

where

a are identical or different and are represented by an integer from 1 to 300

where

X are identical or different and are represented by a branched or straight-chain C₁- to C₁₀-alkyl radical, C₅- to C₈-cycloalkyl radical, aryl radical, heteroaryl radical or H, preferably H,

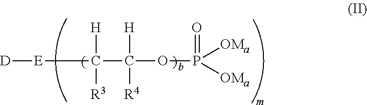

where

D are identical or different and are represented by a substituted or unsubstituted heteroaromatic compound having 5 to 10 C atoms

where

E are identical or different and are represented by N, NH or O

where

m is 2 if E is N and m is 1 if E is NH or O

where

R³ and R⁴, independently of one another, are identical or different and are represented by a branched or straight-chain C₁- to C₁₀-alkyl radical, C₅- to C₈-cycloalkyl radical, aryl radical, heteroaryl radical or H

where

b are identical or different and are represented by an integer from 1 to 300

where

M is independently of one another an alkaline metal ion, alkaline earth metal ion, ammonium ion, organic ammonium ion and/or H, a is 1 or in the case of alkaline earth metal ions ½.

The groups A and D in the general formulae (I) and (II) of the polycondensate are preferably represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, it being possible for A and D to be chosen independently of one another and also in each case to consist of a mixture of said compounds. The groups B and E, independently of one another, are preferably represented by O. The radicals R¹, R², R³ and R⁴ can be chosen independently of one another and are preferably represented by H, methyl, ethyl or phenyl, particularly preferably by H or methyl and especially preferably by H.

In general formula (I) a is preferably represented by an integer from 1 to 300, in particular 3 to 200 and particularly preferably 5 to 150 and b in general formula (II) by an integer from 1 to 300, preferably 1 to 50 and particularly preferably 1 to 10. The respective radicals, the length of which is defined by a and b, respectively, may consist here of uniform building blocks, but a mixture of different building blocks may also be expedient. Furthermore, the radicals of the general formulae (I) or (II), independently of one another, may each have the same chain length, a and b each being represented by a number. As a rule, however, it will be expedient if mixtures having different chain lengths are present in each case so that the radicals of the structural units in the polycondensate have different numerical values for a and independently for b.

Frequently, the phosphated polycondensate according to the invention has a weight average molecular weight of 5.000 g/mol to 200.000 g/mol, preferably 10.000 to 100.000 g/mol and particularly preferably 15.000 to 55.000 g/mol.

The phosphated polycondensate can be present also in form of its salts, as for example the sodium, potassium, organic ammonium, ammonium and/or calcium salt, preferably as the sodium and/or calcium salt.

Typically the molar ratio of the structural units (I):(II) is 1:10 to 10:1, preferably 1:8 to 1:1. It is advantageous to have a relatively high proportion of structural units (II) in the polycondensate because a relatively high negative charge of the polymers has a good influence on the stability of the suspensions.

In a preferred embodiment of the invention the polycondensate contains a further structural unit (III) which is represented by the following formula

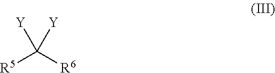

where

Y, independently of one another, are identical or different and are represented by (I), (II), or further constituents of the polycondensate

where

R⁵ are identical or different and are represented by H, CH₃, COOH or a substituted or unsubstituted aromatic or heteroaromatic compound having 5 to 10 C atoms, preferably H

where

R⁶ are identical or different and are represented by H, CH₃, COOH or a substituted or unsubstituted aromatic or heteroaromatic compound having 5 to 10 C atoms, preferably H.

The polycondensates are typically prepared by a process in which (I) at least one structural unit consisting of an aromatic or heteroaromatic moiety bearing a polyether side chain (for example poly(ethyleneglycol)monophenyl ether) and (II) at least one structural unit consisting of an aromatic or heteroaromatic moiety bearing at least one phosphoric acid ester group and/or a salt of the phosphoric acid ester group (for example phenoxyethanol phosphoric acid ester) are reacted with (IIIa) a monomer having a keto group. Preferably the monomer having a keto group is represented by the general formula (IIIa),

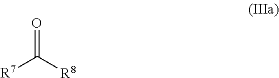

where

R⁷ are identical or different and are represented by H, CH_{3,} COOH and/or a substituted or unsubstituted aromatic or heteroaromatic compound having 5 to 10 C atoms, preferably H,

where

Ware identical or different and are represented by H, CH₃, COOH and/or a substituted or unsubstituted aromatic or heteroaromatic compound having 5 to 10 C atoms, preferably H. Preferably the monomer having a keto group is selected from the group of ketones, preferably being an aldehyde, most preferably formaldehyde. Examples for chemicals according to general structure (IIIa) are formaldehyde, acetaldehyde, acetone, glyoxylic acid and/or benzaldehyde. Formaldehyde is preferable.

Typically R⁵ and R⁶ in structural unit (III), independently of one another, are identical or different and are represented by H, COOH and/or methyl. Most preferable is H.

In another preferred embodiment of the invention the molar ratio of the structural units [(I)+(II)]:(III) is 1:0.8 to 3 in the polycondensate. Preferably the polycondensation is carried out in the presence of an acidic catalyst, this catalyst preferably being sulphuric acid, methanesulphonic acid, para-toluenesulphonic acid or mixtures thereof. The polycondensation and the phosphation are advantageously carried out at a temperature between 20 and 150° C. and a pressure between 1 and 10 bar. In particular, a temperature range between 80 and 130° C. has proved to be expedient. The duration of the reaction may be between 0.1 and 24 hours, depending on temperature, the chemical nature of the monomers used and the desired degree of crosslinking. Crosslinking can preferably occur if monosubstituted monomers of structural unit I and/or II are used because the condensation reaction can occur in the two ortho positions and the para position. Once the desired degree of polycondensation has been reached, which can also be determined, for example, by measurement of the viscosity of the reaction mixture, the reaction mixture is cooled.

The reaction mixture might be subjected to a thermal after treatment at a pH between 8 and 13 and a temperature between 60 and 130° C. after the end of the condensation and phosphation reaction. As a result of the thermal after treatment, which advantageously lasts for between 5 minutes and 5 hours, it is possible substantially to reduce the aldehyde content, in particular the formaldehyde content, in the reaction solution. Alternatively the reaction mixture can be subjected to a vacuum treatment or other methods known in the prior art to reduce the content of (form)aldehyde.

In order to obtain a better shelf life and better product properties, it is advantageous to treat the reaction solutions with basic compounds. It is therefore to be regarded as being preferred to react the reaction mixture after the end of the reaction with a basic sodium, potassium, ammonium or calcium compound. Sodium hydroxide, potassium hydroxide, ammonium hydroxide or calcium hydroxide has proved to be particularly expedient here, it being regarded as being preferred to neutralize the reaction mixture. However, other alkali metal and alkaline earth metal salts and salts of organic amine are suitable as salts of the phosphated polycondensates as well.

Mixed salts of the phosphated polycondensates can also be prepared by reaction of the polycondensates with at least two basic compounds.

The catalyst used can also be separated off. This can conveniently be done via the salt formed during the neutralization. If sulphuric acid is used as a catalyst and the reaction solution is treated with calcium hydroxide, the calcium sulphate formed can be separated off, for example, in a simple manner by filtration.

Furthermore, by adjusting the pH of the reaction solution to 1.0 to 4.0, in particular 1.5 to 2.0, the phosphated polycondensate can be separated from the aqueous salt solution by phase separation and can be isolated. The phosphated polycondensate can then be taken up in the desired amount of water. However, other methods known to the person skilled in the art, such as dialysis, ultrafiltration or the use of an ion exchanger, are also suitable for separating off the catalyst.

It is possible that the hardening accelerators according to this invention contain also water-soluble comb polymers, which are suitable as plasticizer for hydraulic binders. These compounds are well-known under the term polycarboxylate ethers (PCE) in the field of construction chemicals as a water-reducer for cementitious systems.

Preferably the water-soluble comb polymer suitable as a plasticizer for hydraulic binders is present as a copolymer which contains, on the main chain, side chains having ether functions and acid functions.

The water-soluble comb polymer suitable as a plasticizer for hydraulic binders can be present as a copolymer which is produced by free radical polymerization in the presence of acid monomer, preferably carboxylic acid monomer, and polyether macromonomer, so that altogether at least 45 mol %, preferably at least 80 mol %, of all structural units of the copolymer are produced by incorporation of acid monomer, preferably carboxylic acid monomer, and polyether macromonomer in the form of polymerized units. Acid monomer is to be understood as meaning monomers which are capable of free radical copolymerization, have at least one carbon double bond, contain at least one acid function, preferably a carboxylic acid function, and react as an acid in an aqueous medium. Furthermore, acid monomer is also to be understood as meaning monomers which are capable of free radical copolymerization, have at least one carbon double bond, form at least one acid function, preferably a carboxylic acid function, in an aqueous medium as a result of a hydrolysis reaction and react as an acid in an aqueous medium (example: maleic anhydride or hydrolysable esters of (meth)acrylic acid). In the context of the present invention, polyether macromonomers are compounds which are capable of free radical copolymerization, have at least one carbon double bond, and have at least two ether oxygen atoms, with the proviso that the polyether macromonomer structural units present in the copolymer have side chains which contain at least two ether oxygen atoms, preferably at least 4 ether oxygen atoms, more preferably at least 8 ether oxygen atoms, most preferably at least 15 ether oxygen atoms.

Structural units, which do not constitute an acid monomer or a polyether macromonomer can be for example styrene and derivatives of styrene (for example methyl substituted derivatives), vinyl acetate, vinyl pyrrolidon, butadiene, vinyl proprionate, unsaturated hydrocarbons like for example ethylene, propylene and/or (iso)butylene. This listing is a non-exhaustive enumeration. Preferable are monomers with not more than one carbon double bond.

In a preferred embodiment of the invention the water-soluble comb-polymer suitable as plasticizer for hydraulic binders is a copolymer of styrene and a half ester of maleic acid with a monofunctional polyalkylene glycol. Preferably such a copolymer can be produced by free radical polymerization of the monomers styrene and maleic anhydride (or maleic acid) in a first step. In the second step polyalkylene glycols, preferably alkyl polyalkylene glycols (preferably alkyl polyethylene glycols, most preferably methyl polyethyleneglycol) are reacted with the copolymer of styrene and maleic anhydride in order to achieve an esterification of the acid groups. Styrene can be completely or partially replaced by styrene derivatives, for example methyl substituted derivatives. Copolymers of this preferred embodiment are described in U.S. Pat. No. 5,158,996, the disclosure of which is incorporated into the present patent application.

Frequently, a structural unit is produced in the copolymer by incorporation of the acid monomer in the form polymerized units, which structural unit is in accordance with the general formulae (Ia), (Ib), (Ic) and/or (Id)

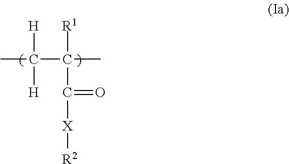

where

R¹ are identical or different and are represented by H and/or a non-branched chain or a branched C₁-C₄ alkyl group;

X are identical or different and are represented by NH—(CₙH₂ₙ) where n=1, 2, 3 or 4 and/or O—(CₙH₂ₙ) where n=1, 2, 3 or 4 and/or by a unit not present;

R² are identical or different and are represented by OH, SO₃H, PO₃H₂, O—PO₃H₂ and/or para-substituted C₆H₄-SO₃H, with the proviso that, if X is a unit not present, R² is represented by OH;

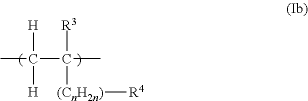

where

R³ are identical or different and are represented by H and/or a non-branched chain or a branched C₁-C₄ alkyl group;

n=0, 1, 2, 3 or 4

R⁴ are identical or different and are represented by SO₃H, PO₃H₂, O—PO₃H₂ and/or para-substituted C₆H₄-SO₃H;

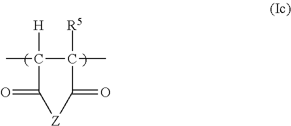

where

R⁵ are identical or different and are represented by H and/or a non-branched chain or a branched C₁-C₄ alkyl group;

Z are identical or different and are represented by O and/or NH;

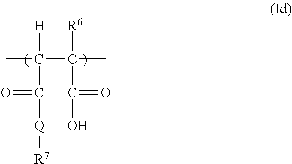

where

R⁶ are identical or different and are represented by H and/or a non-branched chain or a branched C₁-C₄ alkyl group;

Q are identical or different and are represented by NH and/or O;

R⁷ are identical or different and are represented by H, (CₙH₂ₙ)—SO₃H where n=0, 1, 2, 3 or 4, preferably 1, 2, 3 or 4, (CₙH₂ₙ)—OH where n=0, 1, 2, 3 or 4, preferably 1, 2, 3 or 4; (CₙH₂ₙ)—PO₃H₂ where n=0, 1, 2, 3 or 4, preferably 1, 2, 3 or 4, (CₙH₂ₙ)—OPO₃H₂ where n=0, 1, 2, 3 or 4, preferably 1, 2, 3 or 4, (C₆H₄)—SO₃H, (C₆H₄)—PO₃H₂, (C₆H₄)—OPO₃H₂ and/or (CₘH₂ₘ)ₑ—O—(A′O)_{α}—R⁹ where m=0, 1, 2, 3 or 4, preferably 1, 2, 3 or 4, e=0, 1, 2, 3 or 4, preferably 1, 2, 3 or 4, A′=C_{x′}H_{2x′}, where x′=2, 3, 4 or 5 and/or CH₂C(C₆H₅)H—, α=an integer from 1 to 350 where R⁹ are identical or different and are represented by a non-branched chain or a branched C₁-C₄ alkyl group.

Typically, a structural unit is produced in the copolymer by incorporation of the polyether macromonomer in the form of polymerized units, which structural unit is in accordance with the general formulae (IIa), (IIb) (IIc) and/or (IId)

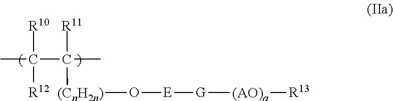

where

R¹⁰, R¹¹ and R¹² are in each case identical or different and, independently of one another, are represented by H and/or a non-branched chain or a branched C₁-C₄ alkyl group;

E are identical or different and are represented by a non-branched chain or branched C₁-C₆ alkylene group, preferably C₂-C₆ alkylene group, a cyclohexylen group, CH₂-C₆H₁₀, ortho-, meta- or para-substituted C₆H₄ and/or a unit not present;

G are identical or different and are represented by O, NH and/or CO—NH, with the proviso that, if E is a unit not present, G is also present as a unit not present;

A are identical or different and are represented by CₓH₂ₓ where x=2, 3, 4 and/or 5 (preferably x=2) and/or CH₂CH(C₆H₅);

n are identical or different and are represented by 0, 1, 2, 3, 4 and/or 5;

a are identical or different and are represented by an integer from 2 to 350 (preferably 10-200);

R¹³ are identical or different and are represented by H, a non-branched chain or a branched C₁-C₄ alkyl group, CO—NH₂, and/or COCH₃;

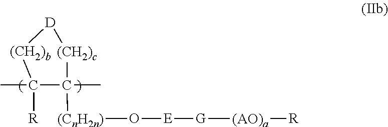

where

R¹⁴ are identical or different and are represented by H and/or a non-branched chain or branched C₁-C₄ alkyl group;

E are identical or different and are represented by a non-branched chain or branched C₁-C₆ alkylene group, preferably a C₂-C₆ alkylene group, a cyclohexylen group, CH₂-C₆H₁₀, ortho-, meta- or para-substituted C₆H₄ and/or by a unit not present;

G are identical or different and are represented by a unit not present, O, NH and/or CO—NH, with the proviso that, if E is a unit not present, G is also present as a unit not present;

A are identical or different and are represented by CₓH₂ₓ where x=2, 3, 4 and/or 5 and/or CH₂CH(C₆H₅);

n are identical or different and are represented by 0, 1, 2, 3, 4 and/or 5

a are identical or different and are represented by an integer from 2 to 350;

D are identical or different and are represented by a unit not present, NH and/or O, with the proviso that if D is a unit not present: b=0, 1, 2, 3 or 4 and c=0, 1, 2, 3 or 4, where b+c=3 or 4, and

with the proviso that if D is NH and/or O, b=0, 1, 2 or 3, c=0, 1, 2 or 3, where b+c=2 or 3;

R¹⁵ are identical or different and are represented by H, a non-branched chain or branched C₁-C₄ alkyl group, CO—NH₂, and/or COCH₃;

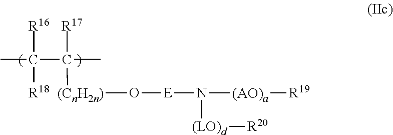

where

R¹⁶, R¹⁷ and R¹⁸ are in each case identical or different and, independently of one another, are represented by H and/or a non-branched chain or branched C₁-C₄ alkyl group;

E are identical or different and are represented by a non-branched chain or a branched C₁-C₆ alkylene group, preferably a C₂-C₆ alkylene group, a cyclohexylen group, CH₂-C₆H₁₀, ortho-, meta- or para-substituted C₆H₄ and/or by a unit not present;

A are identical or different and are represented by CₓH₂ₓ where x=2, 3, 4 and/or 5 and/or CH₂CH(C₆H₅);

n are identical or different and are represented by 0, 1, 2, 3, 4 and/or 5;

L are identical or different and are represented by CₓH₂ₓ where x=2, 3, 4 and/or 5 and/or CH₂-CH(C₆H₅);

a are identical or different and are represented by an integer from 2 to 350;

d are identical or different and are represented by an integer from 1 to 350;

R¹⁹ are identical or different and are represented by H and/or a non-branched chain or a branched C₁-C₄ alkyl group,

R²⁰ are identical or different and are represented by H and/or a non-branched chain C₁-C₄ alkyl group,

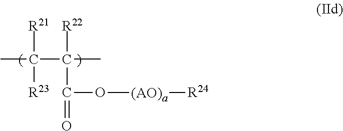

where

R²¹, R²² and R²³ are in each case identical or different and, independently of one another, are represented by H and/or a non-branched chain or branched C₁-C₄ alkyl group;

A are identical or different and are represented by CₓH₂ₓ where x=2, 3, 4 and/or 5 and/or CH₂CH(C₆H₅);

a are identical or different and are represented by an integer from 2 to 350;

R²⁴ are identical or different and are represented by H and/or a non-branched chain or a branched C₁-C₄ alkyl group, preferably a C₁-C₄ alkyl group.

Alkoxylated isoprenol and/or alkoxylated hydroxybutyl vinyl ether and/or alkoxylated (meth)allyl alcohol and/or vinylated methylpolyalkylene glycol having preferably in each case an arithmetic mean number of 4 to 340 oxyalkylene groups is preferably used as the polyether macromonomer. Methacrylic acid, acrylic acid, maleic acid, maleic anhydride, a monoester of maleic acid or a mixture of a plurality of these components is preferably used as the acid monomer.

In a further embodiment of the invention the reaction is carried out completely or partially in the presence of an aqueous solution containing a viscosity enhancer polymer, selected from the group of polysaccharide derivatives and/or (co)polymers with an average molecular weight M_{w} higher than 500.000 g/mol, more preferably higher than 1.000.000 g/mol, the (co)polymers containing structural units derived (preferably by free radical polymerization) from non-ionic (meth)acrylamide monomer derivatives and/or sulphonic acid monomer derivatives. It is possible that the viscosity enhancer polymer is added at the beginning, during the process or at the end of the process. For example it can be added to the aqueous solution of the water-soluble polymer according to this invention, to the calcium compound and/or the silicate compound. The viscosity enhancer polymer can also be used during the process of preparing a hardening accelerator composition by reaction of a calcium compound, preferably a calcium salt, most preferably a water-soluble calcium salt with a silicon dioxide containing component. Preferably the viscosity enhancer polymer is added at the end of the reaction (at the end of the reactants addition) in order to prevent any particles to be destabilized and to keep the best stability. The viscosity enhancer has a stabilizing function in that segregation (aggregation and sedimentation) of for example calcium silicate hydrate) can be prevented. Preferably the viscosity enhancers are used at a dosage from 0.001 to 10 weight %, more preferably 0.001 to 1 weight % with respect to the weight of the hardening accelerator suspension. The viscosity enhancer polymer preferably should be dosed in a way that a plastic viscosity of the hardening accelerator suspensions higher than 80 mPa·s is obtained.

As polysaccharide derivative preference is given to cellulose ethers, for example alkylcelluloses such as methylcellulose, ethylcellulose, propylcellulose and methylethylcellulose, hydroxyalkylcelluloses such as hydroxyethylcellulose (HEC), hydroxypropylcellulose (HPC) and hydroxyethylhydroxypropylcellulose, alkylhydroxyalkylcelluloses such as methylhydroxyethylcelluose (MHEC), methylhydroxypropylcelluose (MHPC) and propylhydroxypropylcellulose. Preference is given to the cellulose ether derivatives methylcellulose (MC), hydroxypropylcellulose (HPC), hydroxyethylcellulose (HEC) and ethylhydroxyethylcellulose (EHEC), and particular preference is given to methylhydroxyethylcelluose (MHEC) and methylhydroxypropyl- celluose (MHPC). The abovementioned cellulose ether derivatives, which can in each case be obtained by appropriate alkylation or alkoxylation of cellulose, are preferably present as non ionic structures, however it would be possible to use for example also carboxymethylcellulose (CMC). In addition, preference is also given to using non ionic starch ether derivatives such as hydroxypropylstarch, hydroxyethylstarch and methyl-hydroxypropylstarch. Preference is given to hydroxypropylstarch. Preferable are also microbially produced polysaccharides such as welan gum and/or xanthans and naturally occurring polysaccharides such as alginates, carregeenans and galactomannans. These can be obtained from appropriate natural products by extractive processes, for example in the case of alginates and carregeenans from algae, in the case of galactomannans from carob seeds.

The viscosity enhancer (co)polymers with a weight average molecular weight M_{w} higher than 500.000 g/mol, more preferably higher than 1.000.000 g/mol can be produced (preferably by free radical polymerization) from non-ionic (meth)acrylamide monomer derivatives and/or sulphonic acid monomer derivatives. The respective monomers can be selected for example from the group of acrylamide, preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide and/or N-tert- butylacrylamide and/or sulphonic acid monomer derivatives selected from the group of styrene sulphonic acid, 2-acrylamido-2-methylpropanesulphonic acid, 2-nnethacrylamido-2-methylpropanesulphonic acid, 2-acrylamidobutanesulphonic acid, and/or 2-acrylamido-2,4,4-trimethylpentanesulphonic acid or the salts of the acids mentioned. It is preferable that the viscosity enhancer contains more than 50 mol %, more preferably more than 70 mol % of structural units derived from non-ionic (meth)acrylamide monomer derivatives and/or sulphonic acid monomer derivatives. Other structural units preferably being contained in the copolymers can be derived from for example the monomers (meth)acrylic acid, esters of (meth)acrylic acid with branched or non-branched C1 to C10 alcohols, vinyl acetate, vinyl proprionate and/or styrene.

In a further embodiment of the invention the viscosity enhancer polymer is a polysaccharide derivative selected from the group of methylcellulose, hydroxyethylcellulose (HEC), hydroxypropylcellulose (HPC), methylhydroxyethylcellulose (MHEC), methylhydroxypropylcellulose (MHPC) and/or (co)polymers with an average molecular weight Mw higher than 500.000 g/mol, more preferably higher than 1.000.000 g/mol, the (co)polymers containing structural units derived (preferably by free radical polymerization) from non-ionic (meth)acrylamide monomer derivatives selected from the group of acrylamide, preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide and/or N-tert-butylacrylamide and/or sulphonic acid monomer derivatives selected from the group of 2-acrylamido-2-methylpropanesulphonic acid, 2-methacrylamido-2-methylpropanesulphonic acid, 2-acrylamidobutanesulphonic acid, and/or 2-acrylamido-2,4,4-trimethylpentane-sulphonic acid or the salts of the acids mentioned.

Within the group of non-ionic (meth)acrylamide monomer derivatives preference is given to methylacrylamide, N,N-dimethylacrylamide and/or methacrylamide, and particular preference is given to acrylamide. Within the group of sulphonic acid monomers 2-acrylamido-2-methylpropanesulphonic acid (AMPS) and its salts are preferable. The viscosity enhancer polymers can be added at the beginning of the process or at any other time.

In a further embodiment of the invention the reaction is carried out completely or partially in the presence of an aqueous solution containing hardening accelerators selected from the group of alkanolamines, preferably triisopropanolamine and/or tetrahydroxyethyl ethylene diamine (THEED). Preferably the alkanolamines are used at a dosage from 0.01 to 2.5 weight % with respect to the weight of hydraulic binder, preferably cement. Synergistic effects could be found when using amines, especially triisopropanolamine and tetrahydroxyethyl ethylene diamine, with respect to the early strength development of hydraulic binder systems, especially cementitious systems. Preferably the amine is added at the end of the reaction.

In another embodiment the reaction is carried out completely or partially in the presence of an aqueous solution containing setting retarders selected from the group of citric acid, tartaric acid, gluconic acid, phosphonic acid, amino-trimethylenphosphonic acid, ethylendiaminotetra(methylenphosphonic) acid, diethylentriaminopenta(methylenphosphonic) acid, in each case including the respective salts of the acids, pyrophosphates, pentaborates, metaborates and/or sugars (e.g. glucose, molasses). The advantage of the addition of setting retarders is that the open time can be controlled and in particular if necessary can be prolonged. The term “open-time” is understood by the person skilled in the art as the time interval after preparing the hydraulic binder mixture until the point of time at which the fluidity is considered as not sufficient anymore to allow a proper workability and the placement of the hydraulic binder mixture. The open-time depends on the specific requirements at the job site and on the type of application. As a rule the precast industry requires between 30 and 45 minutes and the ready-mix concrete industry requires about 90 minutes of open-time. Preferably the setting retarders are used at a dosage from 0.01 to 0.5 weight % with respect to the weight of hydraulic binder, preferably cement. The retarders can be added at the beginning of the process or at any other time.

In a preferred embodiment the hardening accelerator composition obtained according to any of the above mentioned embodiments is dried, preferably by a spray drying process. The drying method is not especially limited, another possible drying method is for example the use of a fluid bed dryer. It is generally known that water, also if only in low quantities, is detrimental to many binders, especially cement, because of undesired premature hydration processes. Powder products with their typically very low content of water are advantageous compared to aqueous systems because it is possible to mix them into cement and/or other binders like gypsum, calcium sulphate hemihydrate (bassanite), anhydrous calcium sulphate, slags, preferably ground granulated blast furnace slag, fly ash, silica dust, metakaolin, natural pozzolan, calcined oil shale, calcium sulphoaluminate cement and/or calcium aluminate cement.

The invention furthermore relates to a hardening accelerator composition which is obtainable by the process described above.

The hardening accelerator suspensions can also contain any formulation component typically used in the field of construction chemicals, preferably defoamers, air entrainers, retarders, shrinkage reducers, redispersible powders, other hardening accelerators, anti-freezing agents and/or anti-efflorescence agents.

The invention comprises the use of a hardening accelerator composition obtainable according to any of the processes of the present invention in building material mixtures containing cement, gypsum, anhydrite, slag, preferably ground granulated blast furnace slag, fly ash, silica dust, metakaolin, natural pozzolans, calcined oil shale, calcium sulphoaluminate cement and/or calcium aluminate cement, preferably in building material mixtures which contain substantially cement as a hydraulic binder.

Gypsum comprises in this context all possible calcium sulphate carriers with different amounts of crystal water molecules, like for example also calcium sulphate hemihydrate.

The invention also concerns building material mixtures, which contain a product obtainable according to any of the processes of this invention and cement, gypsum, anhydrite, slag, preferably ground granulated blast furnace slag, fly ash, silica dust, metakaolin, natural pozzolans, calcined oil shale, calcium sulpho aluminate cement and/or calcium aluminate cement. Preferably the building material mixtures contain substantially cement as a hydraulic binder. The hardening accelerator composition is contained in the building material mixture preferably at a dosage of 0,05 weight % to 5 weight % with respect to the clinker weight.

For illustration the term building material mixtures can mean mixtures in dry or aqueous form and in the hardened or plastic state. Dry building material mixtures could be for example mixtures of said binders, preferably cement and the hardening accelerator compositions (preferably in powder form) according to this invention. Mixtures in aqueous form, usually in the form of slurries, pastes, fresh mortar or fresh concrete are produced by the addition of water to the binder component(s) and the hardening accelerator composition, they transform then from the plastic to the hardened state.

### EXAMPLES

### Preparation of Accelerator Compositions (Reaction of Calcium Compound and Silicate Compound)

TABLE 1
Synthesis conditions used for each accelerator composition

| | Quantity | | | | | | | | |
|---|---|---|---|---|---|---|---|---|---|
| | and type of | | | | | | | Stirring | |
| | Polymers | Composition | Composition | Composition | Mixing Procedure with | | T | Rate | Total Solid |
| ID | used | of Solution 1 | of Solution 2 | of Solution 3 | feeding rates | | ° C. | (rpm) | Content |
| Acc. 1 | 98.2 g of | 92.7 g Na2SiO3•5H2O + | 116.01 g | Polymers + | 1 in 3 at | 2 in 3 at | 20° | 300 | 22.50% |
| | BNS | 260.8 g | Ca(NO3)2 + | 293.91 g Water | 90.6 ml/hour | 52.8 mL/hour | | | |
| | Melcret 500 | Water | 133.81 g Water | | | | | | |
| Acc. 2 | 5.85 g of | 10.76 g | 12 g Ca(NO3)2 + | Polymer + | 1 in 3 at | 2 in 3 at | 20° | 300 | 2.60% |
| | Borresperse | Na2SiO3•5H2O + | 11.06 g Water | 929.6 g Water | 70.2 ml/hour | 31.2 mL/hour | | | |
| | NA246 | 30.29 g | | | | | | | |
| | | Water | | | | | | | |
| Acc. 3 | No Polymer | 39.71 g | 49.65 g | 732.4 g Water | 1 in 3 at | 2 in 3 at | 20° | 300 | 7.90% |
| | | Na2SiO3•5H2O + | Ca(NO3)2 + | | 103.8 ml/hour | 51 mL/hour | | | |
| | | 111.6 g | 45.76 g Water | | | | | | |
| | | Water | | | | | | | |
| Acc. 4 | No Polymer | 93.72 g | 117.3 g | 380.2 g Water | 1 in 3 at | 2 in 3 at | 20° | 300 | 18.90% |
| | | Na2SiO3•5H2O + | Ca(NO3)2 + | | 45 ml/hour | 91.8 mL/hour | | | |
| | | 263.3 g | 108.11 g Water | | | | | | |
| | | Water | | | | | | | |
| Acc. 5 | No Polymer | 39.71 g | 49.65 g | 732.4 g Water | 1 in 3 at | 2 in 3 at | 20° | 300 | 100% |
| | | Na2SiO3•5H2O + | Ca(NO3)2 + | | 103.8 ml/hour | 51 mL/hour | | | |
| | | 111.6 g | 45.76 g Water | | | | | | |
| | | Water | | | | | | | |

For preparing the accelerator compositions the solutions 1 to 3 were prepared and solutions 1 (sodium silicate solution) and 2 (calcium nitrate solution) were dosed at the indicated feeding rates into solution 3. Solution 3 contains a water-soluble polymer according to this invention (Acc. 1 and Acc. 2) or is just water (comparison examples Acc. 3, Acc. 4 and Acc. 5). The stirring rate(s) and the temperature are controlled during the whole synthesis. After the addition of the reactants, the suspension is further mixed for 30 minutes and afterwards collected and stored. The amounts are adjusted for achieving around 1kg of suspension at the end of the synthesis.

The solid content of the suspension is measured by drying 3g+/−0,1g of the suspension in a crucible in porcelain 24 hours in an oven at 60° C.

The active solid content is calculated with the following method. We consider that the active content is the total solid weight (given by the measured solid content) minus the organic part, minus the sodium ions and minus the nitrate ions. The organic part, the sodium and nitrate ions are simply deducted from syntheses.

Borresperse NA246 is sodium lignosulphonate, which is commercially available from the company Lignotech. Melcret® 500 L is a BNS obtainable from BASF Construction Chemicals GmbH.

### Mortar Tests—Compressive and Flexural Strength

It is known in the state of the art that mortar tests are qualitatively representative of the performance in concretes. Mortars tests are therefore used to compare efficiencies of the different accelerator compositions with the reference mortar mix (without any accelerator) and the usual accelerators known by the skilled person.

### Preparation

The preparation of mortars follows the Norm EN 196-1.

The ingredients are the following:

225 g of total water

450 g of cement

1350 g of norm-sand

The dosage of the accelerator compositions to be tested is expressed as weight percentage of suspension with respect to the cement weight and the corresponding percentages of active content are indicated in brackets (please see table 3).

BB42.5R is a Bernburg CEM I 42,5R (17.10.2008) from the company Schwenk.

The mortar tests were done at a constant water to cement ratio (W/C) of 0.5. As usual the water contained in the accelerator is to be deducted from the batching water.

The accelerator is mixed into the batching water.

Steel forms are filled with the mortar mix and then were cured at 20° C. The compressive and flexural strengths are measured at 6, 10 and 24 hours.

The results of the mortar tests are represented in table 2.

The reference mortar mix number 1 does not contain any accelerator, whereas the mixes 2 to 9 are mortar mixes containing state of the art accelerators, used here as comparison examples. Mixes 10 and 11 contain the accelerators according to this invention Acc. 1 and Acc. 2.

TABLE 2
Compressive and flexural strength of mortar samples

| | | | Compressive | | | Flexural Strength | | |
|---|---|---|---|---|---|---|---|---|
| | | | Strength (MPa) | | | (MPa) | | |
| Mix | | Acceler- | 6 | 10 | 24 | 6 | 10 | 24 |
| ID | Cement | ator | hours | hours | hours | hours | hours | hours |
| 1 | BB425,5 | | 0.6 | 3.0 | 18.1 | ~0 | 0.78 | 4.25 |
| 2 | BB42,5R | 0.5% | 1.0 | 3.5 | 16.9 | 0.22 | 0.97 | 4.13 |
| | | Ca(NO3)₂ | | | | | | |
| 3 | BB42,5R | 1% | 1.0 | 3.6 | 15.1 | 0.24 | 0.91 | 3.51 |
| | | Ca(NO3)2 | | | | | | |
| 4 | BB42,5R | 2% | 1.2 | 3.3 | 13.3 | 0.36 | 0.89 | 3.18 |
| | | Ca(NO3)2 | | | | | | |
| 5 | BB42,5R | 0.5% | 1.2 | 3.6 | 19.6 | 0.28 | 1.01 | 4.53 |
| | | CaCl2 | | | | | | |
| 6 | BB42,5R | 1% CaCl2 | 1.9 | 4.3 | 18.9 | 0.46 | 1.39 | 4.17 |
| 7 | BB42,5R | 7.8% | 1.0 | 3.5 | 17.0 | 0.28 | 0.95 | 4.04 |
| | | Acc.3 | | | | | | |
| | | (0.35%) | | | | | | |
| 8 | BB42,5R | 3.6% | 0.9 | 3.9 | 18.3 | 0.20 | 1.07 | 4.14 |
| | | Acc.4 | | | | | | |
| | | (0.35%) | | | | | | |
| 9 | BB42,5R | 38.9% | 0.9 | 2.9 | 18.4 | ~0 | 0.95 | 3.92 |
| | | Acc.5 | | | | | | |
| | | (0.35%) | | | | | | |
| 10 | BB42,5R | 33.3% | 1.3 | 5.9 | 18.4 | 0.39 | 1.64 | 4.79 |
| | | Acc.2 | | | | | | |
| | | (0.3%) | | | | | | |
| 11 | BB42,5R | 4.2% | 1.5 | 4.1 | 18.5 | 0.3 | 1.28 | 4.3 |
| | | Acc.1 | | | | | | |
| | | (0.35%) | | | | | | |

The results show that especially after 6 and 10 hours the compressive and flexural strength development is improved by the mixes 10 (containing Acc. 2 with a lignosulphonate) and 11 (containing Acc. 1 with BNS) compared to the blank (mix 1) and to the mixes 2 to 6 containing state of the art accelerators based on calcium nitrate and calcium chloride. The mixes containing state of the art calcium silicate hydrate do not reach the relatively high strength values as the hardening accelerators according to this invention.

1. Process for the preparation of a hardening accelerator composition by reaction of a water-soluble calcium compound with a water-soluble silicate compound, the reaction of the water-soluble calcium compound with the water-soluble silicate compound being carried out in the presence of an aqueous solution of a water-soluble polymer, which contains sulphonic acid and/or sulphonate groups and aromatic groups.

2. Process according to claim 1, wherein the components are used in the following ratios:
i) 0.01 to 75, optionally 0.01 to 51, further optionally 0.01 to 15% by weight of water-soluble calcium compound,
ii) 0.01 to 75, optionally 0.01 to 55, further optionally 0.01 to 10% by weight of water-soluble silicate compound,
iii) 0.001 to 60, optionally 0.1 to 30, further optionally 0.1 to 10% by weight of water-soluble polymer, which contains sulphonic acid and/or sulphonate groups and aromatic groups.
iv) 24 to 99, optionally 50 to 99, further optionally 70 to 99% by weight of water.

3. Process according to claim 1 wherein the water-soluble calcium compound is present as calcium chloride, calcium nitrate, calcium formate, calcium acetate, calcium bicarbonate, calcium bromide, calcium carbonate, calcium citrate, calcium chlorate, calcium fluoride, calcium gluconate, calcium hydroxide, calcium oxide, calcium hypochloride, calcium iodate, calcium iodide, calcium lactate, calcium nitrite, calcium oxalate, calcium phosphate, calcium propionate, calcium silicate, calcium stearate, calcium sulphate, calcium sulphate hemihydrate, calcium sulphate dihydrate, calcium sulphide, calcium tartrate, calcium aluminate, tricalcium silicate and/or dicalcium silicate.

4. Process according to claim 3, wherein the water-soluble calcium compound is present as calcium citrate, calcium tartrate, calcium formate and/or calcium sulphate.

5. Process according to claim 3, wherein the water-soluble calcium compound is present as calcium chloride and/or calcium nitrate.

6. Process according to claim 1, wherein the water-soluble silicate compound is present as sodium silicate, potassium silicate, waterglass, aluminium silicate, tricalcium silicate, dicalcium silicate, calcium silicate. silicic acid, sodium metasilicate and/or potassium metasilicate.

7. Process according to claim 6, wherein the water-soluble silicate compound is present as sodium metasilicate, potassium metasilicate and/or waterglass.

8. Process for the preparation of a hardening accelerator composition by reaction of a calcium compound, optionally a calcium salt, further optionally a water-soluble calcium salt with a silicon dioxide containing component under alkaline conditions, wherein the reaction is carried out in the presence of an aqueous solution of a water-soluble polymer, which contains sulphonic acid and/or sulphonate groups and aromatic groups.

9. Process for the preparation of a hardening accelerator according to claim 8, wherein the calcium compound is calcium hydroxide and/or calcium oxide.

10. Process for the preparation of a hardening accelerator according to claim 8, wherein the silicon dioxide containing compound is selected from microsilica, pyrogenic silica, precipitated silica, blast furnace slag, and/or quartz sand.

11. Process for the preparation of a hardening accelerator according to claim 8, wherein the pH-value is higher than 9.

12. Process according to claim 8, wherein the molar ratio of calcium from the calcium compound to silicon from the silicon dioxide containing component is from 0.6 to 2, optionally 1.1 to 1.8.

13. Process according to claim 8, wherein the weight ratio of water to the sum of calcium compound and silicon dioxide containing component is from 0.2 to 50, optionally 2 to 10, further optionally 4 to 6.

14. Process according to claim 1 in which the water-soluble polymer is a polycondensate.

15. Process according to claim 1 in which the polymer is a plasticizer for hydraulic binders selected from lignosulphonates, naphthalene sulphonate formaldehyde condensates and/or melamine sulphonate formaldehyde condensates.

16. Process according to claim 1 in which the average molecular weight M_{w} of the polymer is between 1,000 and 100,000 g/mol.

17. Process according to claim 1, wherein the reaction is carried out completely or partially in the presence of an aqueous solution containing hardening accelerators selected from alkanolamines. optionally triisopropanolamine and/or tetrahydroxyethyl ethylene diamine.

18. Process according to claim 1, wherein the reaction is carried out completely or partially in the presence of an aqueous solution containing setting retarders selected from citric acid, tartaric acid, gluconic acid, phosphonic acid, amino-trimethylenphosphonic acid, ethylendiaminotetra(methylenphosphonic) acid, diethylentriaminopenta(methylenphosphonic) acid, in each case including the respective salts, pyrophosphates, pentaborates. metaborates and/or sugars thereof.

19. Process according to claim 1, followed by a process step in which the hardening accelerator composition is dried, optionally by a spray drying process.

20. Hardening accelerator composition obtained by the process according to claim 1.

21. Method of using a hardening accelerator composition according to claim 20 in building material mixtures containing cement, gypsum, anhydrite, slag, ground granulated blast furnace slag, fly ash, silica dust, metakaolin. natural pozzolanas, calcined oil shale. calcium sulpho aluminate cement and/or calcium aluminate cement as binder, optionally in building material mixtures which contain substantially cement as a hydraulic binder, comprising adding water to the binder and the hardening accelerator composition to produce the mixture.

22. Building material mixtures containing a hardening accelerator composition according to claim 20 and cement, gypsum, anhydrite, slag, ground granulated blast furnace slag, fly ash, silica dust, metakaolin, natural pozzolanas, calcined oil shale, calcium sulpho aluminate cement and/or calcium aluminate cement.

23. Process according to claim 8 in which the water-soluble polymer is a polycondensate.

24. Process according to claim 8 in which the polymer is a plasticizer for hydraulic binders selected from lignosulphonates, naphthalene sulphonate formaldehyde condensates and/or melamine sulphonate formaldehyde condensates.

25. Process according to claim 8 in which the average molecular weight M_{w} of the polymer is between 1,000 and 100,000 g/mol.

26. Process according to claim 8, wherein the reaction is carried out completely or partially in the presence of an aqueous solution containing hardening accelerators selected from alkanolamines, optionally triisopropanolamine and/or tetrahydroxyethyl ethylene diamine.

27. Process according to claim 8, wherein the reaction is carried out completely or partially in the presence of an aqueous solution containing setting retarders selected from citric acid, tartaric acid, gluconic acid, phosphonic acid, amino-trimethylenphosphonic acid, ethylendiaminotetra(methylenphosphonic) acid, diethylentriaminopenta(methylenphosphonic) acid, in each case including the respective salts, pyrophosphates, pentaborates, metaborates and/or sugars thereof.

28. Process according to claim 8, followed by a process step in which the hardening accelerator composition is dried, optionally by a spray drying process.

29. Hardening accelerator composition obtained by the process according to claim 8.

30. Method of using a hardening accelerator composition according to claim 29 in building material mixtures containing cement, gypsum, anhydrite, slag, ground granulated blast furnace slag, fly ash, silica dust, metakaolin, natural pozzolanas, calcined oil shale, calcium sulpho aluminate cement and/or calcium aluminate cement as binder, optionally in building material mixtures which contain substantially cement as a hydraulic binder, comprising adding water to the binder and the hardening accelerator composition to produce the mixture.

31. Building material mixtures containing a hardening accelerator composition according to claim 29 and cement, gypsum, anhydrite, slag, ground granulated blast furnace slag, fly ash, silica dust, metakaolin, natural pozzolanas, calcined oil shale, calcium sulpho aluminate cement and/or calcium aluminate cement.
